(19) United States
(12) Patent Application Publication
(10) Pub. No.: US 2019/0389142 A1
(43) Pub. Date: Dec. 26, 2019

(54) VACUUM PACKAGE MACHINE AND VACUUM PACKAGE METHOD

(71) Applicant: TOYO JIDOKI CO., LTD., Tokyo (JP)

(72) Inventors: Yoshiteru INOUE, Iwakuni-shi (JP); Yasuyuki HONDA, Iwakuni-shi (JP)

(21) Appl. No.: 16/447,078

(22) Filed: Jun. 20, 2019

(30) Foreign Application Priority Data
Jun. 26, 2018 (JP) 2018-121256

(51) Int. Cl. B29C 65/08; B29C 65/00; B29C 65/34; B29C 65/66; B29C 65/78

(52) U.S. Cl. CPC B29C 65/08; B29C 66/8491; B29C 65/7897; B29C 65/665; B29C 65/7867; B29C 65/34

(57) ABSTRACT

A packaging device includes a first sealing device which performs a first sealing process based on an impulse seal method on a bag in a chamber being in a vacuum state. A second sealing device performs a second sealing process based on a heat plate sealing method on a planned seal portion of the bag. A cooling device cools the bag. A discharge unit receives, in the release position, the bag released from the transfer mechanism after the cooling process. The transfer mechanism linearly transfers the bag in a direction along a surface of the bag from the delivery position to the release position.

### CROSS-REFERENCE TO RELATED APPLICATIONS

This application is based upon and claims the benefit of priority from Japanese Patent Application No. 2018-121256, filed on Jun. 26, 2018; the entire contents of which are incorporated herein by reference.

### TECHNICAL FIELD

The present invention relates to a vacuum package machine and a vacuum package method.

### BACKGROUND ART

Japanese patent application publication Nos. 2004-67177, 1-99924 and 9-48409 disclose vacuum package machines. A vacuum package machine generally degasses and seals a bag containing contents to provide a package bag inside which the contents are disposed and which is sealed in a vacuum state.

### SUMMARY OF INVENTION

### Technical Problem

In a vacuum package machine, the entire desired area of a bag may be sealed by means of a single sealing process, or the entire desired area of a bag may be sealed by means of a plurality of sealing processes. For example, a first sealing process (also referred to as a “temporary sealing process”) for sealing the mouth portion of a bag may be performed under a vacuum environment, and subsequently a second sealing process for sealing the mouth portion of the bag may be performed under the atmospheric pressure (also referred to as a “main sealing process”). In this case, the first sealing process provides a bag with a seal for preventing the outside air from invading from the outside of the bag while maintaining the inside of the bag in a vacuum state. In addition, the second sealing process can improve the reliability of the seal and adjust the seal portion to a desired shape. Therefore, the above-mentioned first sealing process can be performed in a necessary and sufficient range for maintaining the inside of a bag in a vacuum state, and is usually performed on a relatively narrow range of a bag. On the other hand, the second sealing process is usually performed on a relatively wide range of a bag.

While various sealing methods can be used in the first sealing process and the second sealing process, sealing methods different from each other may be adopted in the first sealing process and the second sealing process in order to achieve the sealing performance required for the respective processes. For example, in the first sealing process, an impulse sealing method or an ultrasonic sealing method capable of rapidly sealing a narrow range of a bag is suitably employed. On the other hand, in the second sealing process, a heat plate sealing method capable of reliably and quickly sealing a wide range of a bag is suitably employed.

According to an impulse sealing method, a sealing device is inexpensive and the method can be relatively easily introduced into a vacuum package machine. However, if a part of the contents adheres to the inner seal portion of a bag due to vibration or boiling during a degassing process of the contents (in particular, liquid substances), the impulse seal type of sealing process might be difficult to remove the adhered materials from the seal portion, so that the seal portion might not be always properly sealed. On the other hand, in a sealing process of an ultrasonic sealing method, thanks to ultrasonic waves, the seal portion can be sealed while the adhered material can be removed from the seal portion. However, sealing devices adopting an ultrasonic sealing method are generally more expensive than sealing devices adopting an impulse sealing method. Therefore, if it is required to provide a vacuum package machine at low cost, a sealing device adopting an impulse sealing method is preferable to a sealing device adopting an ultrasonic sealing method.

On the other hand, a sealing process adopting a heat plate sealing method uses a relatively large heat plate maintained at a high temperature for a long time, and thus a highly reliable sealing can be applied to a bag, but the installable place is limited and for example, it is difficult to install in a vacuum chamber a sealing device adopting a heat plate sealing method. Therefore, from the viewpoint of achieving both vacuum airtight property of a bag and a reliable sealing process at low cost, the first sealing process is performed using an impulse type sealing device, and subsequently the second sealing process is performed using a heat plate type sealing device.

By the way, in order to perform a series of processes required for the vacuum packaging processing at high speed and continuously, an apparatus adopting a rotary system may be used. According to a rotary system, a bag is rotated and transported by a rotary table, and the bag receives processes at a plurality of stations provided on the transport path. In such a rotary system, as the number of stations provided on the transport path increases, a bag can be subjected to more various processes, but the diameter of the rotary table needs to be increased and a larger installation space is required to be secured. In particular, in a case where, while a bag is transported by the rotary table, it is required to performed a process for determining whether the sealing is properly applied to a bag (also referred to as a “seal determination process”) in addition to the first sealing process and the second sealing process described above, the diameter of the rotary table needs to be further increased.

The present invention has been made in view of the above-described circumstances, and it is an object of the present invention to provide an apparatus and a method capable of appropriately performing a first sealing process and a second sealing process while expansion of the space required for processes is curbed.

### Solution to Problem

One aspect of the present invention is directed to a vacuum package machine comprising: a packaging device including a first sealing device which performs a first sealing process based on an impulse seal method on a bag in a chamber being in a vacuum state while rotationally moving the bag around a package rotation axis, a content being accommodated inside of the bag; a transfer mechanism which receives the bag having been subjected to the first sealing process at a delivery position and transfers the bag to at least a seal position, a cooling position, and a release position in turn; a second sealing device which performs a second sealing process based on a heat plate sealing method on a planned seal portion of the bag in the seal position; a cooling device which performs a cooling process in which the bag is cooled in the cooling position; and a discharge unit which receives, in the release position, the bag released from the transfer mechanism after the cooling process, wherein the transfer mechanism linearly transfers the bag in a direction along a surface of the bag from the delivery position to the release position.

The transfer mechanism may include: a plurality of transfer holding units which is capable of holding the bag; and a moving body which causes the plurality of transfer holding units to move in an integrated manner and reciprocates in each of a first direction parallel to a direction from the delivery position toward the release position and a second direction that is not parallel to the first direction, and the moving body may cause the plurality of transfer holding units to move in the first direction and in the second direction.

A plurality of stop positions including the delivery position, the seal position, the cooling position and the release position may be provided parallel to the first direction at equal intervals, number of the plurality of transfer holding units may be one less than number of the plurality of stop positions, the plurality of transfer holding units placed in an upstream side arrangement state may be arranged respectively in stop positions of the plurality of stop positions other than a most downstream stop position, and the plurality of transfer holding units placed in a downstream side arrangement state may be arranged respectively in stop positions of the plurality of stop positions other than the delivery position, and the moving body: may move the plurality of transfer holding units placed in the upstream side arrangement state in the first direction to place the plurality of transfer holding units in the downstream side arrangement state, and may move the plurality of transfer holding units placed in the downstream side arrangement state in the second direction and in the first direction to place the plurality of transfer holding units in the upstream side arrangement state.

A plurality of relay holding units capable of holding the bag may be provided respectively at least in stop positions of the plurality of stop positions other than the delivery position and the most downstream stop position, each of the plurality of relay holding units may receive and hold the bag from a corresponding transfer holding unit of the plurality of transfer holding units placed in the downstream side arrangement state, the moving body may place the plurality of transfer holding units in the upstream side arrangement state after the bag is released from each of the plurality of transfer holding units placed in the downstream side arrangement state, and each of the plurality of relay holding units may deliver the bag to a corresponding transfer holding unit of the plurality of transfer holding units placed in the upstream side arrangement state.

The second sealing device may have a heat plate unit which sandwiches the planned seal portion of the bag, and the heat plate unit also may serve as the relay holding unit provided in the stop position corresponding to the seal position.

The vacuum package machine may comprise a delivery device which receives the bag which has been subjected to the first sealing process from the packaging device and delivers the bag to the transfer mechanism, wherein the delivery device may include: a rotation body which is provided to be rotatable; and a plurality of delivery holding units which are attached to the rotation body and are each capable of being arranged in a position where the plurality of delivery holding units are able to receive the bag from the packaging device and in a position where the plurality of delivery holding units is able to deliver the bag to the transfer mechanism according to a rotation state of the rotation body.

The packaging device may further include a filling device which puts the content inside the bag while rotationally moving the bag about a filling rotation axis, and the transfer mechanism may transfer the bag from the delivery position to the release position substantially parallel to a straight line connecting the filling rotation axis and the package rotation axis.

The vacuum package machine may comprise a state determination device which determines, after the second sealing process, a state of an inspection range of the bag that at least partially includes the planned seal portion.

The vacuum package machine may comprise a sorting device which sorts the bag after being received by the discharge unit according to a determination result of the state of the inspection range.

Another aspect of the present invention is directed to a vacuum package method comprising the steps of: performing a first sealing process based on an impulse seal method on a bag in a chamber being in a vacuum state while rotationally moving the bag around a package rotation axis, a content being accommodated inside of the bag; taking the bag having been subjected to the first sealing process out of the chamber and delivering the bag to a transfer mechanism arranged in a delivery position; conveying the bag from the delivery position to a seal position by the transfer mechanism; performing a second sealing process based on a heat plate sealing method on a planned seal portion of the bag in the seal position; performing a cooling process which cools the bag in a cooling position; and releasing the bag after the cooling process from the transfer mechanism in a release position, wherein the transfer mechanism linearly transfers the bag in a direction along a surface of the bag from the delivery position to the release position.

According to the present invention, a first sealing process and a second sealing process can be appropriately performed while expansion of the space required for processes is curbed.

### BRIEF DESCRIPTION OF DRAWINGS

FIG. 1 is a plan view showing an overall outline of a vacuum package machine.

FIG. 2 is a plan view showing a configuration of a seal shaping unit.

FIG. 3 is a side view showing the configuration of a delivery device.

FIG. 4 is a plan view showing an example of a bag.

FIG. 5 is a diagram for explaining a movement path of a moving body.

FIG. 6A is a view showing an arrangement example of a relay holding unit and a gripper.

FIG. 6B is a view showing an arrangement example of the relay holding unit and the gripper.

FIG. 7 is a plan view of the seal shaping unit for describing the flow of the transfer of a bag from a first stop position to a fifth stop position.

FIG. 8 is a plan view of the seal shaping unit for describing the flow of the transfer of a bag from the first stop position to the fifth stop position.

FIG. 9 is a plan view of the seal shaping unit for describing the flow of the transfer of a bag from the first stop position to the fifth stop position.

FIG. 10 is a plan view of the seal shaping unit for describing the flow of the transfer of a bag from the first stop position to the fifth stop position.

FIG. 11 is a plan view of the seal shaping unit for describing the flow of the transfer of a bag from the first stop position to the fifth stop position.

### DESCRIPTION OF EMBODIMENTS

Hereinafter, a vacuum package machine and a vacuum package method according to an embodiment of the present invention will be described with reference to the drawings. For convenience, the elements shown in the drawings attached to the present specification may include elements shown in different sizes and shapes from the real thing. There are also drawings in which illustration of some elements is omitted.

In the present invention, for example, the impulse seal type of sealing process and the heat plate seal type of sealing process are distinguished as follows. According to the impulse seal type of sealing process, during the period when the sealing process is not performed, the sealing device for applying a seal to a bag is at a low temperature such that a seal cannot be applied to a bag, but during the period when the sealing process is performed, the sealing device is raised to a high temperature such that a seal can be applied to a bag. On the other hand, a sealing device used for the heat plate seal type of sealing process is basically maintained at a high temperature which enables a bag to be sealed not only during the period when the sealing process is performed but also during the period when the sealing process is not performed, and thus, a seal can be applied to a bag by bringing the bag close to the sealing device (e.g., by bringing the sealing device into contact with the bag). However, the specific configuration and the temperature rising method of sealing devices for realizing these sealing processes are not limited.

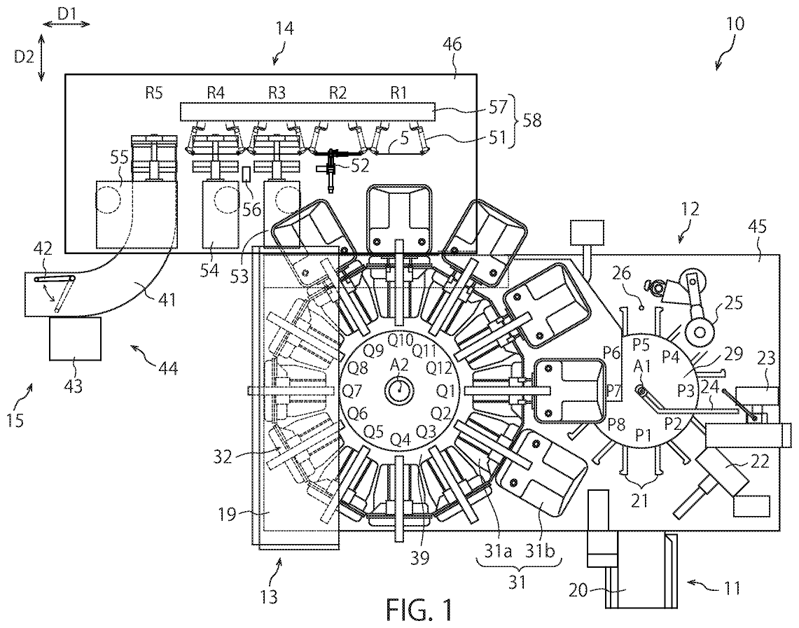

FIG. 1 is a plan view showing the overall outline of a vacuum package machine 10.

The vacuum package machine 10 shown in FIG. 1 includes a storage unit 11, a content filling unit 12, a vacuum processing unit 13, a seal shaping unit 14 and a discharge unit 15.

The storage unit 11 stores bags 5 to be supplied to the content filling unit 12. The illustrated storage unit 11 includes a magazine 20, and a plurality of bags 5 are stored in the magazine 20 in a stacked state. Each bag 5 stored in the magazine 20 takes the form of a so-called flat bag having a layer shape, and the front surface side wall portion and the rear surface side wall portion are in close contact with each other.

The content filling unit 12 functions as a filling device which puts the contents inside a bag 5 while rotationally moving the bag 5 having been received from the storage unit 11 around the filling rotation axis A1. A bag 5 in which the contents are accommodated is delivered from the content filling unit 12 to the vacuum processing unit 13 installed at a later stage. The illustrated content filling unit 12 is a rotary type, and the filling rotor 29 installed on the first mount 45 intermittently rotates about the filling rotation axis A1. A plurality of first grippers 21 attached at equal intervals to the peripheral portion of the filling rotor 29 are intermittently moved and arranged at a plurality of stations P1 to P8.

As an example, a first gripper 21 disposed at the station P1 receives a bag 5 from the magazine 20 via a relay device (not illustrated), a printing device 22 prints information such as the date on a bag 5 at the station P2, an opening device 23 opens the mouth portion of a bag 5 at the station P3, a solid filling device 25 puts the solid contents into a bag 5 through the mouth portion at station P4, a liquid injection device 26 injects the liquid content into a bag 5 through the mouth portion at the station P5, and a bag 5 is delivered from a first gripper 21 to the vacuum processing unit 13 through a relay device (not shown) at the station P7. The content filling unit 12 and the vacuum processing unit 13 are arranged in the first direction D1 and are installed on the first mount 45.

The specific processes performed in the content filling unit 12 are not limited. For example, during the period when a bag 5 moves from the station P3 to the station P4, a follow-up opening guide device 24 may support the mouth portion of the bag 5 while maintaining the mouth portion of the bag 5 in an open state. Also, the solid filling device 25 may comprise a hopper, and the liquid injection device 26 may comprise a nozzle. Further, the station P6 and the station P8 may be vacant stations at which no special processing is performed on bags 5, or any processing may be performed at the station P6 and the station P8.

The vacuum processing unit 13 has a function as a first sealing device that performs a first sealing process of an impulse seal type in a vacuum chamber 31 in a vacuum state on a bag 5 inside which the contents are disposed.

The illustrated vacuum processing unit 13 performs the first sealing process while rotationally moving bags 5 (that is, turning bags 5) in which the contents are put, about a package rotation axis A2. Specifically, the illustrated vacuum processing unit 13 is of a rotary type, and a vacuum rotor 39 installed on the first mount 45 intermittently rotates about the package rotation axis A2. A plurality of vacuum chambers 31 attached at equal intervals to the peripheral portion of the vacuum rotor 39 are intermittently moved and arranged at a plurality of stations Q1 to Q12.

Each vacuum chamber 31 has a chamber body 31a and a chamber lid 31b. The chamber body 31a is fixed to the vacuum rotor 39. The chamber lid 31b is pivotally attached to the corresponding chamber body 31a. The chamber lid 31b is disposed at an open position where the chamber lid 31b is separated from the chamber body 31a so that the inside of the vacuum chamber 31 is opened outward, and at a close contact position where the chamber lid 31b is in close contact with the chamber body 31a so that the inside of the vacuum chamber 31 is cut off from the outside. While the chamber lid 31b is disposed in the close contact position, the inside of the vacuum chamber 31 is kept in an airtight state.

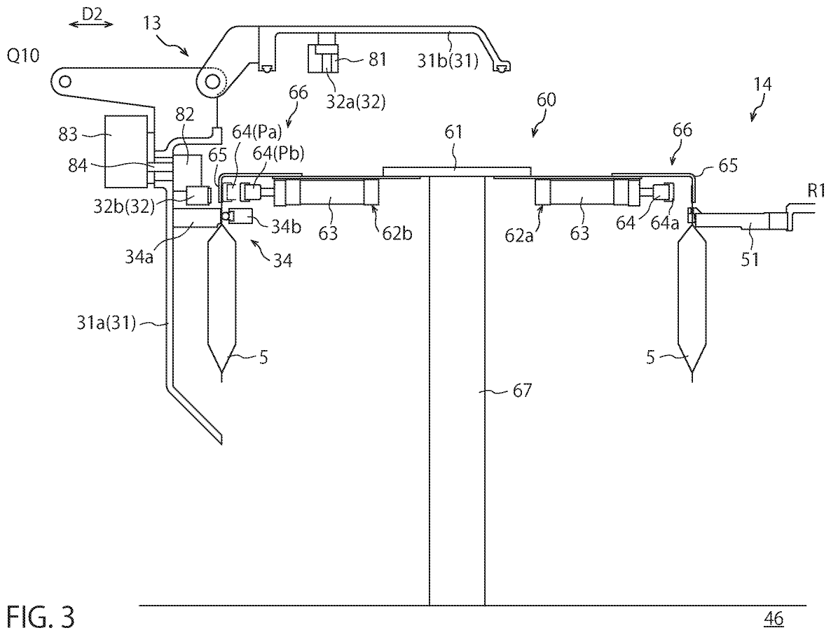

In a vacuum chamber 31, a chamber chuck 34 capable of holding and releasing a bag 5 is provided. The specific configuration of the chamber chuck 34 is not limited, and the chamber chuck 34 can be configured, for example, by a stationary side chuck 34a and a movable side chuck 34b as shown in FIG. 3. When the chamber lid 31b is disposed in the close contact position, the chamber chuck 34 can hold a bag 5 in a suspended state inside the chamber chuck 34. Further, the chamber chuck 34 is provided so as to be openable and closable. For example, a bag 5 can be gripped by sandwiching the bag 5 with the stationary side chuck 34a and the movable side chuck 34b, and a bag 5 can be released from the chamber chuck 34 by moving the movable side chuck 34b away from the stationary side chuck 34a. The chamber chuck 34 needs to grip a bag 5 both when the chamber lid 31b is disposed at the open position and when the chamber lid 31b is disposed at the close contact position. Therefore, the stationary side chuck 34a and the movable side chuck 34b may be attached to the chamber body 31a, for example.

As an example, a vacuum chamber 31 disposed at the station Q1 receives a bag 5 from the content filling unit 12 (in particular, from a first gripper 21 disposed at the station P7) via a relay device (not shown), and the shaping of the bag 5 is performed at the station Q2 to adjust the posture and the shape of the bag 5. Then, in the stations Q3 to Q5, air is exhausted from the inside of a vacuum chamber 31 through an exhaust port (not shown) formed in the vacuum chamber 31, so that the inside of the vacuum chamber 31 is adjusted to a vacuum state. In this situation, the inside of the bag 5 held by the chamber chuck 34 is also degassed to be in a vacuum state. Each chamber lid 31b is disposed at the open position from the station Q9 through the station Q2, and is disposed at the close contact position from the stations Q3 to the station Q8. The timings at which each chamber lid 31b performs the opening and closing operations are not limited. For example, while a vacuum chamber 31 is intermittently stopped at the corresponding station (at the station Q2, Q3, Q8 or Q9 in the illustrated example), the opening and closing operations of the chamber lid 31b may be performed. Alternatively, while a vacuum chamber 31 is moving between corresponding stations, the opening and closing operations of the chamber lid 31b may be performed.

Then, the first sealing process is performed at the station Q6, and a bag 5 (in particular, the portion where the first sealing process has been performed) is cooled at the station Q7 and at the station Q8. The first sealing process is a sealing process of an impulse seal type performed by a first sealing unit 32. Although the specific configuration of the first sealing unit 32 is not limited, each vacuum chamber 31 is provided with the first sealing unit 32.

The illustrated first sealing unit 32 has a heating wire (for example, a nichrome wire) 32a and a receiving pad 32b as shown in FIG. 3. The heating wire 32a is fixed to the chamber lid 31b via a stationary block 81. The receiving pad 32b is fixed to the chamber body 31a via a movable block 82, an advancing-retracting shaft 84 and an advancing-retracting drive unit 83. The advancing-retracting drive unit 83 advances and retracts the advancing-retracting shaft 84 in the horizontal direction. The horizontal positions of the movable block 82 and the receiving pad 32b also change in accordance with the advancement and retraction of the advancing-retracting shaft 84. For example, when the first sealing process is performed, the chamber lid 31b is disposed at the close contact position, so that the heating wire 32a is disposed at a position facing the receiving pad 32b in the horizontal direction (i.e., the second direction D2). Also, the receiving pad 32b is brought close to the heating wire 32a, and a bag 5 is sandwiched between the heating wire 32a and the receiving pad 32b. With the heating wire 32a and the receiving pad 32b sandwiching a desired part of the bag 5 in this manner, a large current is supplied to the heating wire 32a to raise the temperature of the heating wire 32a at the station Q6. As a result, welding of the part of the bag 5 pinched by heating wire 32a and the receiving pad 32b is performed, so that the first sealing processing can be performed.

The Installation manner of the heating wire and the receiving pad is not limited. Also, the specific method of the cooling processes performed at the station Q7 and the station Q8 is not limited. For example, the application of current to the heating wire 32a may be halted to stop the heating of the heating wire 32a in such a manner that the seal portion of the bag 5 may be naturally cooled together with the heating wire 32a. Further, by separating the heating wire 32a from the sealing portion of the bag 5, the sealing portion may be naturally cooled. Further, the seal portion of the bag 5 may be actively cooled by pressing a solid cooling body against the seal portion or blowing a cooling gas to the seal portion.

Then, at the station Q10, a bag 5 having been subjected to the first sealing process is taken out of a vacuum chamber 31 and is delivered to a second gripper 51 of a transfer mechanism 58 disposed at the delivery position (i.e., a first stop position R1) of the seal shaping unit 14.

The specific processes performed in the vacuum processing unit 13 are not limited. For example, the station Q9, the station Q11 and the station Q12 may be empty stations where no process is performed on a bag 5, and an arbitrary process may be performed on a bag 5 at the station Q9, the station Q11 and the station Q12.

In the illustrated vacuum package machine 10, a control panel 19 is mounted on the first mount 45. The control panel 19 controls each of devices constituting the vacuum package machine 10, and is a control unit that can control not only the processes of the content filling unit 12 and the vacuum processing unit 13 described above but also the processes of the seal shaping unit 14 and the discharge unit 15 described later. Accordingly, the control panel 19 can control the operations of, for example, the filling rotor 29, the printing device 22, the opening device 23, the follow-up opening guide device 24, the solid filling device 25, the liquid injection device 26, the vacuum rotor 39, the vacuum chambers 31 (In particular, the chamber lids 31b) and the first sealing units 32. The specific configuration of the control panel 19 is not limited. For example, the control panel 19 may be configured by a single control device, or the control panel 19 may be configured by a plurality of control devices. While the illustrated control panel 19 is integrally provided, two or more control devices constituting the control panel 19 may be provided at positions separated from each other.

As described above, a bag 5 having been filled with contents and vacuum-sealed in the packaging device including the content filling unit 12 and the vacuum processing unit 13 is supplied to the transfer mechanism 58 of the seal shaping unit 14. The above-mentioned storage unit 11, the content filling unit 12, and the vacuum processing unit 13 are only an example, and those configurations and operations are not limited. For example, the timing at which a bag 5 is filled with the contents and the timing at which the first sealing process is performed on a bag 5 are not limited. Further, the manner of storing bags 5 in the storage unit 11 is not limited. Moreover, the kind and the state of the contents with which a bag 5 is filled are not limited. Furthermore, the deaeration process which puts the inside of a bag 5 in a vacuum state is not limited.

Next, a configuration example of the seal shaping unit 14 will be described.

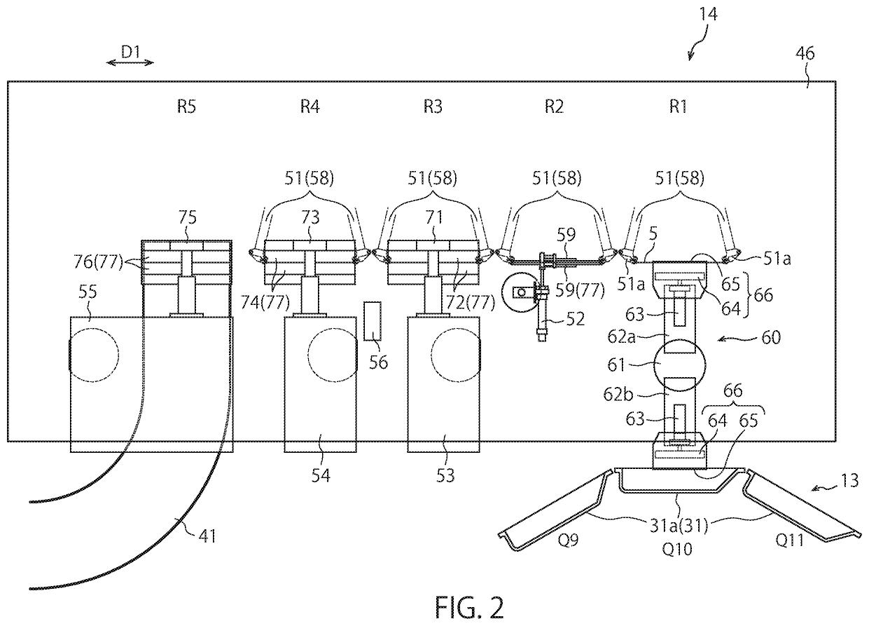

FIG. 2 is a plan view showing the configuration of the seal shaping unit 14. FIG. 3 is a side view showing the configuration of the delivery device 60. In FIG. 2, illustration of the chamber lids 31b is omitted.

The seal shaping unit 14 includes the transfer mechanism 58, a first heat sealing device (i.e., the second sealing device) 53, a second heat sealing device (i.e., the third sealing device) 54, a state determination device 56, a cooling device 55, and a discharge conveyor (i.e., the discharge unit) 41.

The transfer mechanism 58 of the present embodiment receives a bag 5 from the vacuum processing unit 13 via the delivery device 60.

The delivery device 60 receives a bag 5 having been subjected to the first sealing process from the vacuum processing unit (packaging device) 13 and delivers the bag 5 to the transfer mechanism 58 of the seal shaping unit 14. The illustrated delivery device 60 has a rotation body 61 provided rotatably and a plurality of holding units (delivery holding units) 66 (in the illustrated example, two holding units 66) attached to the rotation body 61. According to the rotation state of the rotation body 61, each holding unit 66 is placed in a position where each holding unit 66 can receive a bag 5 from a chamber chuck 34 of the vacuum processing unit 13 and in a position where each holding unit 66 can deliver a bag 5 to a second gripper 51 of the transfer mechanism 58.

In the illustrated delivery device 60, a stand 67 is installed on a second mount 46, and a connection member (not shown) which supports the rotation body 61 is provided inside the stand 67. By rotating this connection member around its axis in the stand 67, the rotation body 61 rotates about its axis along with the connection member. A plurality of support blocks (in the present embodiment, two support blocks: a first support block 62a and a second support block 62b) are attached to the rotation body 61. Each support block comprises an air cylinder 63. A movable chuck 64 is attached to the rod portion of each air cylinder 63, and a stationary chuck 65 is attached to the cylinder portion of each air cylinder 63. Each holding unit 66 is constituted by the movable chuck 64 and the stationary chuck 65 which are arranged so as to face each other in the horizontal direction.

The rod portion of each air cylinder 63 extends in the horizontal direction, and the amount of protrusion in the horizontal direction of the rod portion from the cylinder portion is variable. The relative position of the movable chuck 64 to the stationary chuck 65 is determined depending on the amount of protrusion of the corresponding rod portion. An elastic body 64a is attached to the leading end of the movable chuck 64 on the stationary chuck 65 side. By increasing the protrusion amount of the rod portion of an air cylinder 63 to dispose the movable chuck 64 at a press position Pa, the elastic body 64a is pressed against the stationary chuck 65 via a bag 5, so that the bag 5 is supported by the movable chuck 64 and the stationary chuck 65 in a suspended state. On the other hand, by reducing the protrusion amount of the rod portion of an air cylinder 63 to dispose the movable chuck 64 at a separation position Pb, the elastic body 64a is separated from the stationary chuck 65, so that the bag 5 is released from the holding unit 66.

The relative position between the plurality of holding units 66 (that is, two holding units 66) attached to the rotation body 61 corresponds to the relative position between the position of the chamber chuck 34 of a vacuum chamber 31 disposed at the station Q10 and the position of the second gripper 51 disposed at the first stop position R1 (i.e., the delivery position). Specifically, when one holding unit 66 is arranged at a position where the one holding unit 66 can receive a bag 5 from a chamber chuck 34 arranged at the station Q10, the other holding unit 66 is simultaneously arranged at a position where the other holding unit 66 can deliver a bag 5 to the second gripper 51 arranged at the first stop position R1. Accordingly, the delivery of a bag 5 from the chamber chuck 34 and the delivery of a bag 5 to the second gripper 51 can be performed almost simultaneously, and the time required for processing can be shortened. In the illustrated example, a chamber chuck 34 disposed at the station Q10 and the second gripper 51 disposed at the first stop position R1 are arranged in positions which face each other with respect to the second direction D2 perpendicular to the first direction D1. Accordingly, the two holding units 66 attached to the rotation body 61 are provided at positions which oppose each other, and are disposed on a straight line which passes the rotation axis of the rotation body 61 and extends in the horizontal direction. Three or more (in particular, four or more even number) holding units 66 may be attached to the rotation body 61, but from the viewpoint of reducing the space occupied by the delivery device 60, the two holding units 66 are preferably attached to the rotation body 61.

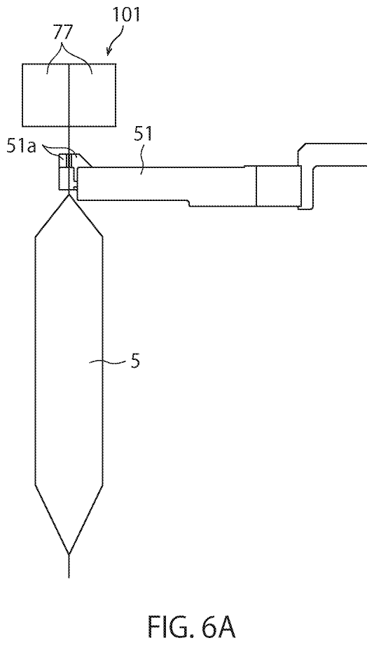

The transfer mechanism 58 receives a bag 5 having been subjected to the first sealing process at the first stop position R1 (i.e., the delivery position), and transfers the bag 5 in the first direction D1 to be placed in at least the seal position, the cooling position, and the release position. The illustrated transfer mechanism 58 has: four grippers (a plurality of transfer holding units) 51 capable of holding a bag 5; and a moving body 57 which supports and integrally moves the four second grippers 51. The moving body 57 is shown in FIGS. 1 and 5 but is omitted in the other drawings. A bag 5 transferred by the four second grippers 51 is arranged at the first stop position R1 (the delivery position), a second stop position R2 (a standby position), a third stop position R3 (a first seal position), a fourth stop position R4 (a second seal position) and a fifth stop position R5 (a cooling position and a releasing position) in turn.

The first stop position R1 corresponds to the delivery position where the transfer mechanism 58 receives a bag 5 from the vacuum processing unit 13. In the illustrated seal shaping unit 14, a bag 5 is received by the second gripper 51 that reciprocates between the first stop position R1 and the second stop position R2, and in particular, the delivery of the bag 5 is performed while the second gripper 51 is at the first stop position R1.

The second stop position R2 corresponds to a standby position where a bag 5 before being transferred to the third stop position R3 waits. A support chuck unit 52 is provided in the second stop position R2, and the support chuck unit 52 has a chuck unit 59 provided so as to be able to open and close. The chuck unit 59 can receive and support a bag 5 from the second gripper 51 that reciprocates between the first stop position R1 and the second stop position R2, and can also deliver a bag 5 to the second gripper 51 that reciprocates between the second stop position R2 and the third stop position R3 to release the bag 5. As described above, each holding unit 66 of the delivery device 60 rotationally moves between the station Q10 of the vacuum processing unit 13 and the first stop position R1 of the seal shaping unit 14, and therefore it is necessary to secure a space where each holding unit 66 can smoothly turn. By providing a standby position (the second stop position R2) between the delivery position (the first stop position R1) and the first seal position (the third stop position R3), such a space required for the turning motion of each holding unit 66 can be properly secured.

The third stop position R3 corresponds to a first seal position for performing a sealing process using a heat plate sealing method on the planned seal portion of a bag 5. Specifically, a first heat sealing device 53 is provided in the third stop position R3, and a sealing process (a second sealing process) using a heat plate sealing method is performed on the planned seal portion of a bag 5 at the third stop position R3 by the first heat sealing device 53. The illustrated first heat sealing device 53 has a first heat plate holding unit 71 and a first heat plate unit 72 supported by the first heat plate holding unit 71. The first heat plate unit 72 has two heat plates and the distance between these heat plates is variable. Specifically, these heat plates can be arranged in a press position where the heat plates are pressed against each other, and in a release position where the heat plates are distanced from each other not to be pressed against each other. The sealing process is performed by causing these heat plates included in the first heat plate unit 72 to sandwich the planned seal portion of a bag 5 disposed at the third stop position R3. The first heat plate unit 72 also functions as a holding portion (i.e., a relay holding unit) provided in the third stop position R3. When the two heat plates of the first heat plate unit 72 are disposed at the press position in a state where a bag 5 is placed between the two heat plates, the two heat plates of the first heat plate unit 72 can support the bag 5 in a suspended state.

The fourth stop position R4 corresponds to a second seal position for performing a sealing process (a third sealing process) using a heat plate sealing method on the planned seal portion of a bag 5. A second heat sealing device 54 is provided in the fourth stop position R4, and the second heat sealing device 54 includes a second heat plate holding unit 73 and a second heat plate unit 74 supported by the second heat plate holding unit 73. The second heat plate unit 74 includes two heat plates. These heat plates can be arranged in a press position where the heat plates are pressed against each other, and in a release position where the heat plates are distanced from each other not to be pressed against each other. The sealing process is performed by causing these heat plates included in the second heat plate unit 74 to sandwich the planned seal portion of a bag 5 disposed at the fourth stop position R4. Further, the second heat plate unit 74 functions as a holding unit (i.e., a relay holding unit) provided in the fourth stop position R4. When the two heat plates of the second heat plate unit 74 are arranged in the press position in a state where a bag 5 is placed between the two heat plates, the two heat plates can support the bag 5 in a suspended state.

The state determination device 56 is provided between the first heat sealing device 53 and the second heat sealing device 54. After the sealing process (the second sealing process) is performed at the third stop position R3, the state determination device 56 determines the state of an inspection range at least partially including the planned seal portion of the second sealing process of a bag 5. The specific detection target of the state determination device 56 (specifically, the type of the state determined by the state determination device 56) is not limited. The illustrated state determination device 56 may determine the temperature state of the inspection range of a bag 5 and may acquire heat distribution data of the determination range of the bag 5 using an infrared detection device such as a thermography device.

The fifth stop position R5 corresponds to a cooling position for performing a cooling processing of a bag 5, and also corresponds to a release position for releasing a bag 5 from the transfer mechanism 58. A cooling device 55 and a discharge conveyor 41 are provided in the fifth stop position R5. After the state determination device 56 determines the state of the inspection range of a bag 5 (In the present embodiment, further after the third sealing process is performed in the fourth stop position R4), the cooling device 55 performs a cooling process which cools the bag 5 in the fifth stop position R5.

The Illustrated cooling device 55 includes a cooling plate holding unit 75 and a cooling plate unit 76 supported by the cooling plate holding unit 75. The cooling plate unit 76 includes two cooling plates. These cooling plates can be arranged in a press position where the cooling plates are pressed against each other, and in a release position where the cooling plates are distanced from each other not to be pressed against each other. The cooling process is performed by causing these cooling plates included in the cooling plate unit 76 to sandwich the planned seal portion of a bag 5 arranged in the fifth stop position R5. Further, the cooling plate unit 76 also functions as a holding unit (a relay holding unit) provided in the fifth stop position R5. When the two cooling plates of the cooling plate unit 76 are arranged in the press position in a state where a bag 5 is placed between the two cooling plates, the two cooling plates can support the bag 5 in a suspended state.

The discharge conveyor 41 receives a bag 5 released from the second gripper 51 of the transfer mechanism 58 in the fifth stop position R5 after the cooling process, and delivers the bag 5 toward the subsequent stage. The vacuum package machine 10 of the present embodiment further includes a sorting device 44 (see FIG. 1) that sorts bags 5 having been received by the discharge conveyor 41 according to the determination results of the state of the inspection range.

The illustrated sorting device 44 includes a discharge lever 42 and a bag receiving unit 43. The discharge lever 42 can selectively push bags conveyed by the discharge conveyor 41 toward the bag receiving unit 43 under the control of the control panel 19. The control panel 19 receives the determination results of the state determination device 56, and controls the sorting device 44 (in particular, the discharge lever 42) according to said determination results. Thus, bags 5 which are determined to have a seal failure based on the determination results of the state determination device 56 are discharged from the discharge conveyor 41 to the bag receiving unit 43 by the sorting device 44, and only bags 5 which are determined not to have a seal failure are sent to the subsequent stage by the discharge conveyor 41.

In the vacuum package machine 10 having the above-described configuration, the transfer mechanism 58 linearly transfers a bag 5 in a direction along the surface of the bag 5, from the delivery position to the release position via the seal position and the cooling position. In the illustrated example, since the cooling position and the release position share the same area, the transfer mechanism 58 linearly transfers a bag 5 from the first stop position R1 up to the fifth stop position R5 via the second stop position R2, the third stop position R3, and the fourth stop position R4. Therefore, the sealing processing based on a heat plate sealing method performed in the third stop position R3 and the fourth stop position R4 is performed on a linear path different from the rotary transfer path in the vacuum processing unit 13. Thus, while suppressing the expansion of the space required for the processing, the first sealing process (i.e., the sealing process based on an impulse sealing method performed by the first sealing unit 32 in the station Q6 of the vacuum processing unit 13), the second sealing process (i.e., the sealing process based on a heat plate sealing method performed by the first heat sealing device 53 in the third stop position R3 of the seal shaping unit 14), and the seal determination process (i.e., the seal determination process performed by the state determination device 56 between the third stop position R3 and the fourth stop position R4) can be appropriately performed.

In particular, the illustrated transfer mechanism 58 transfers a bag 5 from the delivery position (i.e., the first stop position R) to the release position (i.e., the fifth stop position R5) via the seal position and cooling position in the first direction D1 substantially parallel to the straight line connecting the filling rotation axis A1 and the package rotation axis A2. Thus, the expansion of the installation space of the vacuum package machine 10 can be suppressed in the second direction D2 which forms a right angle with respect to the straight line connecting the filling rotation axis A1 and the package rotation axis A2.

Next, the seal position of a bag 5 will be described.

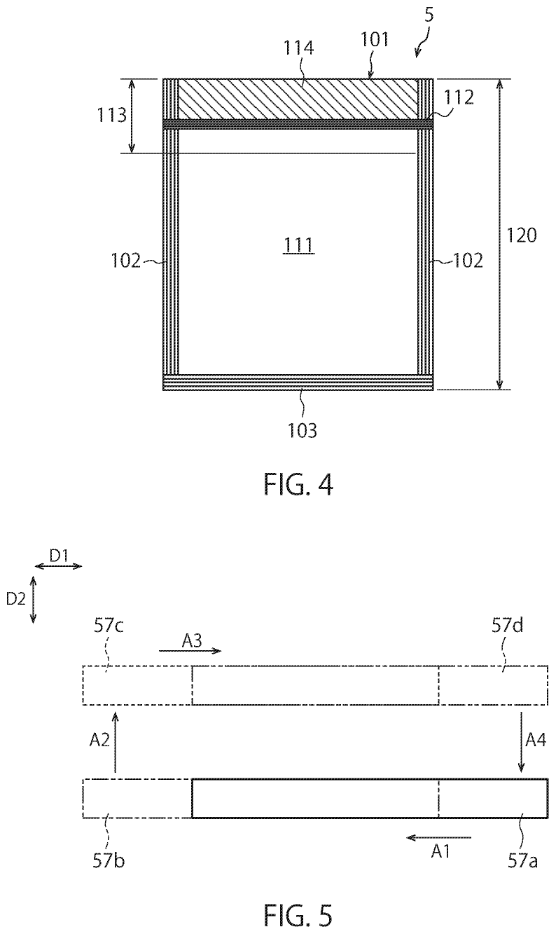

FIG. 4 is a plan view showing an example of a bag 5. The position of each part of the bag 5 shown in FIG. 4 does not necessarily strictly correspond with the position of each part of a real bag.

The bag 5 shown in FIG. 4 has a rectangular planar shape, and the respective sides correspond to the mouth portion 101, the side edge portions 102, and the bottom portion 103, and the mouth portion 101 and the bottom portion 103 are opposite to each other, and both side edge portions 102 are opposite to each other. While the both sides edge portions 102 and the bottom portion 103 of bags 5 stored in the storage unit 11 (see FIG. 1) are closed by sealing, etc., the mouth portion 101 is not closed. Therefore, bags 5 supplied to the content filling unit 12 are placed in a state where the inside of the bags 5 is openable with respect to the outside through the mouth portion 101.

In the station Q6 of the vacuum processing unit 13, a bag 5 is subjected to the first sealing process, so that the weld of the front surface side wall portion and the rear surface side wall portion of the bag 5 is performed in the first seal region 112 of the bag 5. As described above, the first sealing process is an impulse seal type sealing process, and is performed to shield the contents contained in the bag 5 from the open air. Therefore, the first seal region 112 exists at least between the content region 111, which is the region of a bag 5 where the contents are present, and the edge portion of the bag 5 where the mouth portion 101 is formed (In FIG. 4, the upper edge portion). This first seal region 112 does not necessarily extend up to the edge portion of a bag 5 in which the mouth portion 101 is formed, and the first sealing process may be performed with respect to only a limited narrow range of a bag 5. However, in order to shield the contents in a bag 5 from the outside air, the first seal region 112 extends from one side edge portion 102 to the other side edge portion 102 so as not to form a flow path which enables the flow of the outside air into the content region 111.

Then, a bag 5 is subjected to the second sealing process in the third stop position R3 of the seal shaping unit 14, and is subjected to the third sealing process in the fourth stop position R4. In the second sealing process, welding of the front surface side wall portion and the rear surface side wall portion of a bag 5 is performed in the second seal region 114, which is the planned seal portion of the bag 5. Even in the third sealing process, welding of the front surface side wall portion and the rear surface side wall portion of a bag 5 is performed, but the range of a bag 5 for the third sealing process may be the same as or may be different from the range of the second sealing process. The specific range of the second seal region 114 is not limited, and may be a range including part or all of the first seal region 112 or may be a range which does not include the first seal region 112. In the bag 5 shown in FIG. 4, the possible range of the second seal region 114 (i.e., a “second sealable region 113”) is a range that does not overlap the content region 111 in which the contents are disposed. The second seal region 114 of the present embodiment is the entire region of a bag 5 from the position where the first seal region 112 is present up to the edge portion where the mouth portion 101 is formed (in FIG. 4, the upper edge of a bag 5), and the second seal region 114 includes the first seal region 112. Further, the range of the third sealing process is the same as the range of the second sealing process.

When a bag 5 is moved from the third stop position R3 to the fourth stop position R4, data of the temperature state in the inspection range of the bag 5 is acquired by the state determination device 56. As described above, the inspection range is a range which at least partially includes the planned seal portion of a bag 5 where the second sealing process is performed. Therefore, the inspection range may be the whole of a bag 5 including the entire area of the planned seal portion (i.e., the second seal region 114), may be part of a bag 5 but include the entire area of the planned seal portion, or may be a range of a bag 5 which partially includes the planned seal portion. In the present embodiment, the whole of a bag 5 is set to the inspection range 120, and the adequacy of the second sealing process performed by the first heat sealing device 53 is determined from the state of the inspection range 120 determined by the state determination device 56 (specifically, from the temperature state). This determination of the adequacy of the second sealing process may be performed by the state determination device 56, or may be performed by the control panel 19 that receives data about the state of the inspection range 120 from the state determination device 56. Also, the specific determination method of the adequacy of the second sealing process is not limited. For example, the adequacy of the second sealing process may be determined based on whether or not there is a portion having a temperature lower than a predetermined temperature in the inspection range 120, or may be determined based on the range and the position of such a low temperature portion.

Next, a conveyance method of bags 5 performed by the transfer mechanism 58 will be described.

As described above, the transfer mechanism 58 linearly transfers a bag 5 from the first stop position R1 to the fifth stop position R5 in the direction along the surface of the bag 5. Although the specific configuration of the transfer mechanism 58 is not limited, in the illustrated vacuum package machine 10, the moving body 57 performs a so-called box motion in which the moving body 57 moves horizontally along an endless path in such a manner that a bag 5 gripped by each second gripper 51 is transferred in turn from the first stop position R1 toward the fifth stop position R5.

FIG. 5 is a diagram for explaining the movement path of the moving body 57. In FIG. 5, reference numerals “57a”, “57b”, “57c” and “57d” are attached to the moving body arranged at positions different from each other respectively.

The moving body 57 of the present embodiment is moved by a known driving device (not shown) so as to draw a square-like path. Specifically, the moving body 57 moves from the position indicated by the reference numeral 57a in FIG. 5 in a direction (see the reference numeral “A1”) parallel to the first direction D1, and is disposed at the position indicated by the reference numeral 57b. Then, the moving body 57 moves from the position indicated by the reference numeral 57b in a direction parallel to the second direction D2 (see the reference numeral “A2”), and is disposed at the position indicated by the reference numeral 57c. Then, the moving body 57 moves from the position indicated by the reference numeral 57c in a direction (see the reference numeral “A3”) parallel to the first direction D1, and is disposed at the position indicated by the reference numeral 57d. Then, the moving body 57 moves from the position indicated by the reference numeral 57d in a direction (see the reference numeral “A4”) parallel to the second direction D2, and is arranged at the position indicated by the reference numeral 57a again.

The moving body 57 repeats the above-described series of movements, so that and each second gripper 51 attached to the moving body 57 repeats a horizontal movement similar to the moving body 57. Specifically, the moving body 57 causes the plurality of second grippers 51 to move in the first direction D1 parallel to the direction from the delivery position (the first stop position R1) towards the release position (the fifth stop position R5) and in the second direction D2 which is not parallel to the first direction D1. At this time, the moving body 57 reciprocates in each of the first direction D1 and the second direction D2.

In particular, in the illustrated seal shaping unit 14, the plurality of stop positions R1 to R5 including the delivery position, the first seal position, the second seal position, the cooling position, and the release position are provided parallel to the first direction D1 and are provided at equal intervals. Further, the distance between stop positions adjacent to each other among the stop positions R1 to R5 corresponds to the distance between the second grippers 51 adjacent to each other. Further, the number of second grippers 51 provided in the seal shaping unit 14 is “four (4)”, which is one less than the number of stop positions provided in the seal shaping unit 14. Thus, the plurality of second grippers 51 placed in the upstream side arrangement state are respectively arranged at the stop positions other than the most downstream stop position of the plurality of stop positions R1 to R5 (that is, at the stop positions R1 to R4). On the other hand, the plurality of second grippers 51 placed in the downstream side arrangement state are respectively arranged at the stop positions other than the most upstream stop position of the plurality of stop positions R1 to R5 (that is, at the stop positions R2 to R5).

When the moving body 57 moves from the position shown by the reference numeral “57a” in FIG. 5 to the position shown by the reference numeral “57b”, the moving body 57 moves the plurality of second grippers 51 placed in the upstream side arrangement state in the first direction D1 to place the plurality of second grippers 51 in the downstream side arrangement state. Then, when the moving body 57 moves from the position shown by the reference numeral “57b” In FIG. 5 to the position shown by the reference numeral “57a” via the positions shown by the reference numerals “57c” and “57d”, the moving body 57 moves the plurality of second grippers 51 placed in the downstream side arrangement state in the second direction D2 and in the first direction D1 to place the plurality of second grippers 51 in the upstream side arrangement state. The moving body 57 performs the above-mentioned box motion, so that each second gripper 51 is assigned to two specific stop positions adjacent to each other among the plurality of stop positions R1 to R5, and performs a similar box motion between the two assigned stop positions.

A plurality of holding units (specifically, relay holding units 77) capable of holding a bag 5 are provided, among the plurality of stop positions R1 to R5, at least in the respective stop positions other than the delivery position and the most downstream stop position. This does not mean that a case where the relay holding units 77 are provided in the delivery position and the most downstream stop position is excluded. Therefore, for example, the relay holding unit 77 may be provided in the most downstream stop position.

In the illustrated seal shaping unit 14, the plurality of relay holding units 77 are realized by the chuck unit 59 provided at the second stop position R2, the first heat plate unit 72 provided at the third stop position R3, the second heat plate unit 74 provided at the fourth stop position R4, and the cooling plate unit 76 provided at the fifth stop position R5. Each of these relay holding units 77 receives and holds a bag 5 from the corresponding second gripper 51 among the plurality of second grippers 51 placed in the downstream side arrangement state. The moving body 57 places each second gripper 51 in the upstream side arrangement state after a bag 5 is released from each second gripper 51 placed in the downstream side arrangement state. Then, each of the plurality of relay holding units 77 delivers a bag 5 to the corresponding second gripper 51 among the plurality of second grippers 51 placed in the upstream side arrangement state. The transfer mechanism 58 and the relay holding units 77 cooperate to repeatedly perform the above-described operation, whereby bags 5 can be. Intermittently transferred from the first stop position R1 toward the fifth stop position R5, and can be subjected to various processes in each of the plurality of stop positions R1 to R5.

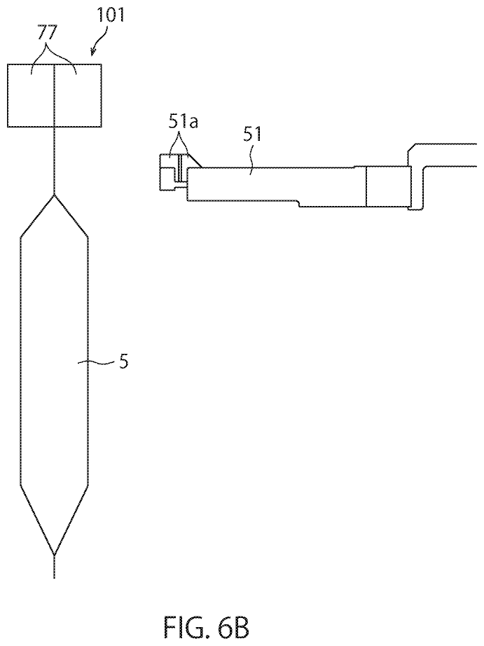

FIGS. 6A and 6B are diagrams showing an arrangement example of a relay holding unit 77 and a second gripper 51. FIG. 6A shows a state in which a relay holding unit 77 also holds a bag 5 gripped by a second gripper 51. FIG. 6B shows a state in which a second gripper 51 is disposed in a position separated from a relay holding unit 77 after a bag 5 is delivered from the second gripper 51 to the relay holding unit 77. After the state shown in FIG. 6A, each second gripper 51 releases the grip of a bag 5 and the moving body 57 moves in the second direction D2 (see the arrow “A2” in FIG. 5), whereby the second gripper 51 is arranged in the position shown in FIG. 6B.

The area of a bag 5 held by the relay holding units 77 and the area of the bag 5 held by each second gripper 51 are shifted in the height direction without overlapping each other, and the relay holding units 77 and the respective second grippers 51 do not collide with each other. In the example shown in FIGS. 6A and 6B, the relay holding unit 77 holds the upper end part of a bag 5 including the edge portion forming the mouth portion 101. On the other hand, each second gripper 51 holds an area of a bag 5 located below the area held by the relay holding unit 77. Specifically, a region of a bag 5 which exists above the content region 111 (see FIG. 4), in which the contents are arranged, and exists below the second seal region 114 is held by each second gripper 51. Each second gripper 51 may hold a bag 5 at the position corresponding to the first seal region 112, or may hold a bag 5 at a position different from the first seal region 112.

Each illustrated second gripper 51 includes opening-closing holders 51a. The opening-closing holders 51a are driven to open and close by air pressure or the like (for example, by an air cylinder). For example, while the transfer mechanism 58 moves a bag 5 between adjacent stop positions of the plurality of stop positions R1 to R5 or when a second gripper 51 receives a bag 5 from a relay holding unit 77, the opening-closing holders 51a are closed and the second gripper 51 grips the bag 5. On the other hand, when a second gripper 51 receives a bag 5 via the delivery device 60 or when a bag 5 is delivered from a second gripper 51 to a relay holding unit 77, the opening-closing holders 51a are opened in such a manner that the second gripper 51 releases the bag 5.

Next, the transfer of a bag 5 from the first stop position R1 to the fifth stop position R5 will be described.

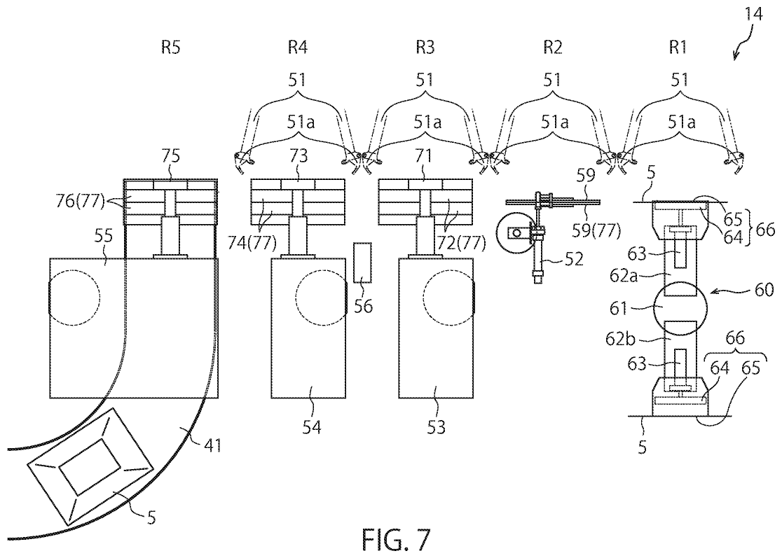

FIGS. 7 to 11 are plan views of the seal shaping unit 14 for describing the flow of transferring a bag 5 from the first stop position R1 to the fifth stop position R5.

First, as shown in FIG. 7, the delivery device 60 places a bag 5 in the first stop position R1. At this time, the moving body 57 (see FIG. 1) is disposed at a position indicated by the reference numeral 57d in FIG. 5. Further, in a state where each second gripper 51 is placed in the upstream side arrangement state, the respective second grippers 51 are disposed at positions away from the relay holding units 77 (specifically, the chuck unit 59, the first heat plate unit 72, the second heat plate unit 74, and the cooling plate unit 76) in the second direction D2.

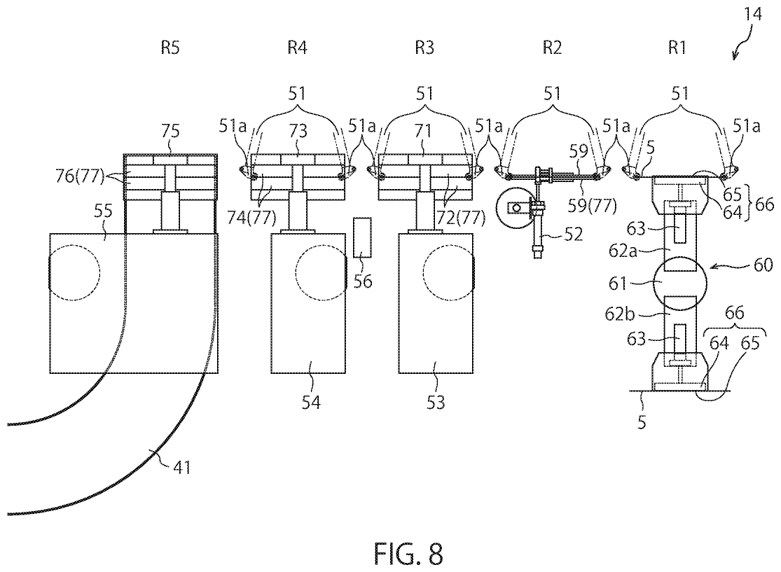

Then, the moving body 57 moves in the second direction D2 (see the arrow “A4” in FIG. 5) in a state where the opening-closing holders 51a of each second gripper 51 are opened, and is arranged in the position indicated by the reference numeral “57a” in FIG. 5. Thereafter, each opening-closing holder 51a is closed. Accordingly, as shown in FIG. 8, each second gripper 51 grips a bag 5 held by the corresponding relay holding unit 77 in a state of being placed in the upstream side arrangement state.

Then, in a state where each second gripper 51 grips the corresponding bag 5, each relay holding unit 77 releases the holding of the corresponding bag 5. At this time, since each second gripper 51 is placed in the upstream side arrangement state, no second gripper 51 is present in the fifth stop position R5. Therefore, a bag 5 released from the relay holding unit 77 (i.e., the cooling plate unit 76) arranged in the fifth stop position R5 falls downward, is placed on the discharge conveyor 41, and is conveyed by the discharge conveyor 41 to the subsequent stage.

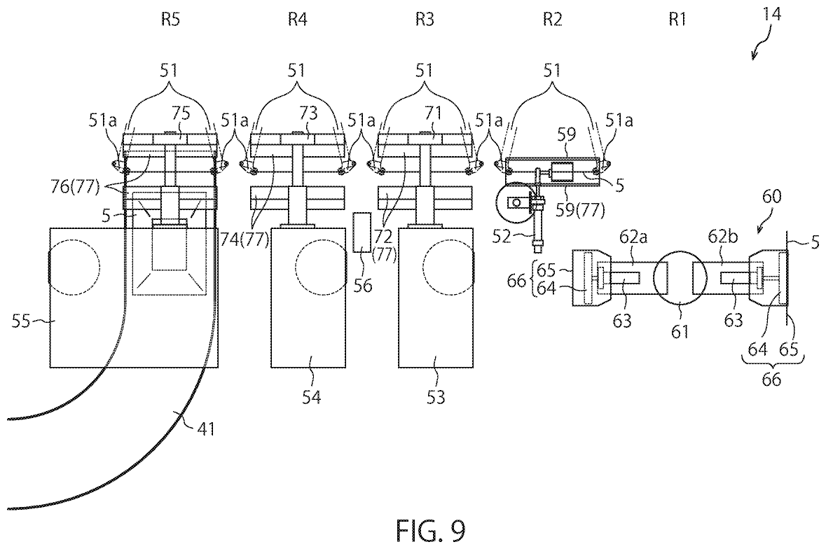

Thereafter, the moving body 57 moves in the first direction D1 (see the arrow “A1” in FIG. 5) and is disposed at the position indicated by the reference numeral “57b” In FIG. 5. Consequently, as shown in FIG. 9, each second gripper 51 is placed in the downstream side arrangement state in a state where each relay holding unit 77 is opened, so that bags 5 gripped by the respective second grippers 51 are arranged between the elements of the corresponding relay holding units 77 (that is, a position between the elements of the chuck unit 59, a position between the elements of the first heat plate unit 72, a position between the elements of the second heat plate unit 74, and a position between the elements of the cooling plate unit 76). At this time, the rotation body 61 of the delivery device 60 is also rotated around the axis by 180 degrees, and consequently a new bag 5 is disposed in the first stop position R1. Further, as the rotation body 61 rotates, the vacuum rotor 39 rotates intermittently, and a new bag 5 is placed in the station Q10 together with a new vacuum chamber 31.

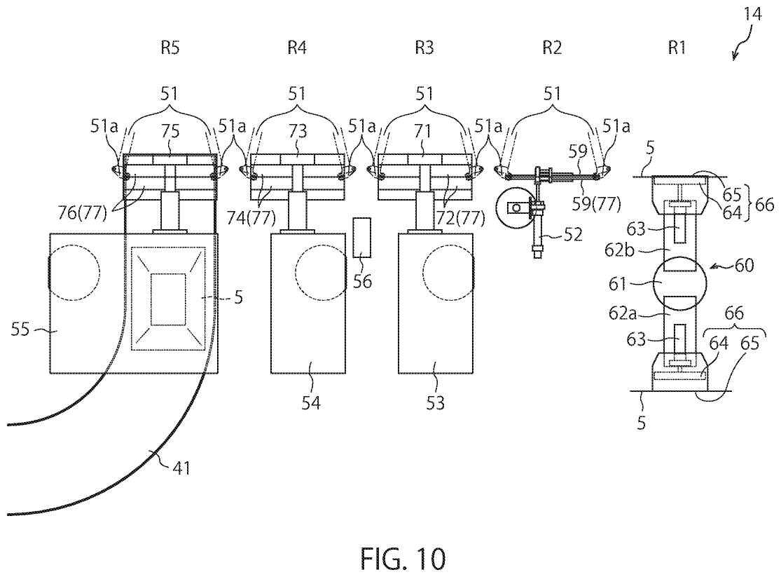

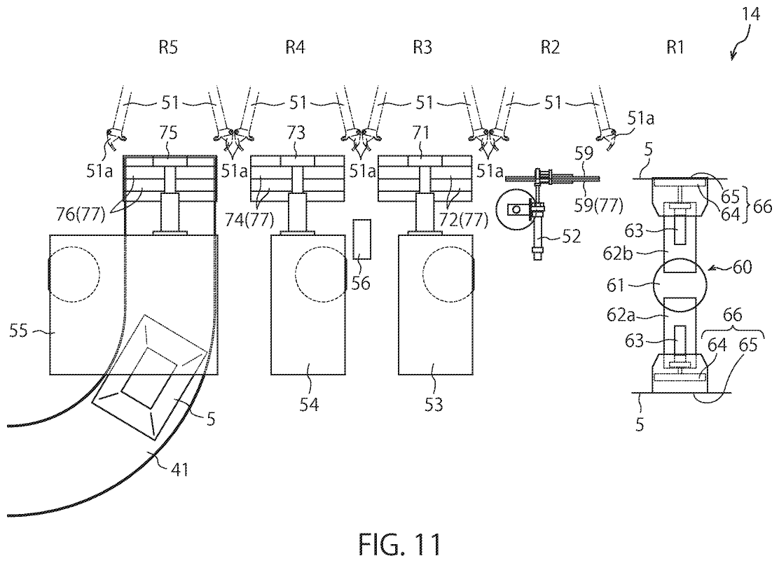

Then, as shown in FIG. 10, each relay holding unit 77 is closed and holds a bag 5 which is gripped by the corresponding second gripper 51. Thereafter, each opening-closing holder 51a is opened, and consequently a bag 5 is released from each second gripper 51. Thereafter, the moving body 57 moves in the second direction D2 (see the arrow “A2” in FIG. 5) to be disposed in the position indicated by the reference numeral “57c” in FIG. 5. As a result, as shown in FIG. 11, each relay holding unit 77 holds a bag 5 and each second gripper 51 is arranged in a position away from the corresponding relay holding unit 77 in the second direction D2 in a state where each second gripper 51 is placed in the downstream side arrangement state. Then, the moving body 57 moves in the first direction D1 (see the arrow “A3” in FIG. 5) and is disposed in the position indicated by the reference numeral “57d” in FIG. 5, so that the seal shaping unit 14 is placed in the state shown in FIG. 7 again.

By repeating the states shown in FIGS. 7 to 11 described above, bags 5 are sequentially transferred from the first stop position R1 towards the fifth stop position R5.

Each device of the seal shaping unit 14 and the discharge unit 15 is controlled by the control panel 19 (see FIG. 1) in such a manner that the above-described operation is performed under the control of the control panel 19.

As described above, according to the vacuum package machine 10 of the present embodiment, while a sealing process based on an impulse sealing method (i.e., the first sealing process) is performed on bags 5 conveyed along an endless path, sealing processes based on a heat plate sealing method (i.e., the second and third sealing processes) and the seal determination process are performed on bags 5 conveyed along a linear path. Thus, in particular, the sealing processes based on a heat plate sealing method and the seal determination process can be performed in a limited space. Therefore, while the expansion of the space required for processing can be curbed, the first sealing process, the second sealing process, the third sealing process and the seal determination process can be appropriately performed.

Further, since the seal determination process is performed on all bags 5, it is possible to provide product bags (that is, bags subjected to the sealing processes) having high reliability with respect to the seal performance. In addition, since the first sealing process is performed based on an impulse sealing method, the apparatus can be provided at low cost as compared with cases of using an ultrasonic sealing apparatus.

Further, the delivery device 60 can simultaneously perform the delivery of a bag 5 from the vacuum processing unit 13 (i.e., a chamber chuck 34) and the delivery of a bag 5 to the seal shaping unit 14 (i.e., a second gripper 51). Therefore, the delivery of bags 5 with respect to the seal shaping unit 14 can be performed smoothly and in a short time.

Further, by utilizing the first heat plate unit 72, the second heat plate unit 74 and the cooling plate unit 76 as relay holding units 77, it is not necessary to provide other dedicated relay holding units. Accordingly, space-saving design is possible and the cost of the apparatus can be reduced.

### [Modifications]

The present invention is not limited to the above-described embodiments and modifications.

For example, dedicated relay holding units 77, which are different from the first heat plate unit 72, the second heat plate unit 74 and the cooling plate unit 76, may be provided in the third stop position R3, the fourth stop position R4, and the fifth stop position R5.

The state determination device 56 may determine the state of a bag 5 after the bag 5 is subjected to the third sealing process in the fourth stop position R4. For example, a state determination device 56 may be installed between the second heat sealing device 54 and the cooling device 55, and during the period when a bag 5 is transferred from the fourth stop position R4 to the fifth stop position R5, the temperature state of the bag 5 may be determined by the state determination device 56.

Also, in the above-described embodiments, bags 5 having a sealing failure are automatically removed from the discharge conveyor 41 by the sorting device 44, but the present invention is not limited to this. For example, an alarm (for example, a lamp or an alarm) may be issued with respect to a bag 5 having a sealing failure under the control of the control panel 19, and the bag 5 may be manually removed from the discharge conveyor 41 by the operator. In addition, a bag 5 having a sealing failure may be discharged while being transferred by the transfer mechanism 58 or may be discharged by a relay holding unit 77. For example, a bag 5 having a sealing failure may be released from a second gripper 51 or a relay holding unit 77 (for example, the second heat plate unit 74) under the control of the control panel 19 after the state of the bag 5 is determined by the state determination device 56 in such a manner that the bag 5 having a sealing failure is dropped downward toward a location other than the discharge conveyor 41 and is discharged.

Moreover, although the moving body 57 of the above-mentioned embodiments moves along a square path shown in FIG. 5, the movement path of the moving body 57 is not limited. The moving body 57 may move along a path of another polygonal shape such as a triangle, for example, or may move along a path of another shape.

Further, in the seal shaping unit 14 of the above-described embodiments, a sealing process based on a heat plate sealing method is performed in a plurality of positions (that is, in the third stop position R3 and the fourth stop position R4), but a sealing process based on a heat plate sealing method may be performed in one position only (for example, in the third stop position R3 only).

Also, various modifications may be added to elements of the above-described embodiments and modifications. Further, the effects exerted by the present invention are not limited to the above-described effects, and specific effects based on the specific configuration of each embodiment may be exerted. As described above, various additions, changes and partial deletions can be made to each element described in the claims, specification, abstract and drawings without departing from the technical concept and spirit of the present invention.

1. A vacuum package machine comprising:
a packaging device including a first sealing device which performs a first sealing process based on an impulse seal method on a bag in a chamber being in a vacuum state while rotationally moving the bag around a package rotation axis, a content being accommodated inside of the bag;
a transfer mechanism which receives the bag having been subjected to the first sealing process at a delivery position and transfers the bag to at least a seal position, a cooling position, and a release position in turn;
a second sealing device which performs a second sealing process based on a heat plate sealing method on a planned seal portion of the bag in the seal position;
a cooling device which performs a cooling process in which the bag is cooled in the cooling position; and
a discharge unit which receives, in the release position, the bag released from the transfer mechanism after the cooling process,
wherein the transfer mechanism linearly transfers the bag in a direction along a surface of the bag from the delivery position to the release position.

2. The vacuum package machine as defined in claim 1, wherein:
the transfer mechanism includes: a plurality of transfer holding units which is capable of holding the bag; and a moving body which causes the plurality of transfer holding units to move in an integrated manner and reciprocates in each of a first direction parallel to a direction from the delivery position toward the release position and a second direction that is not parallel to the first direction, and
the moving body causes the plurality of transfer holding units to move in the first direction and in the second direction.

3. The vacuum package machine as defined in claim 2, wherein:
a plurality of stop positions including the delivery position, the seal position, the cooling position and the release position are provided parallel to the first direction at equal intervals,
number of the plurality of transfer holding units is one less than number of the plurality of stop positions,
the plurality of transfer holding units placed in an upstream side arrangement state are arranged respectively in stop positions of the plurality of stop positions other than a most downstream stop position, and the plurality of transfer holding units placed in a downstream side arrangement state are arranged respectively in stop positions of the plurality of stop positions other than the delivery position, and
the moving body:
moves the plurality of transfer holding units placed in the upstream side arrangement state in the first direction to place the plurality of transfer holding units in the downstream side arrangement state, and
moves the plurality of transfer holding units placed in the downstream side arrangement state in the second direction and in the first direction to place the plurality of transfer holding units in the upstream side arrangement state.

4. The vacuum package machine as defined in claim 3, wherein:
a plurality of relay holding units capable of holding the bag are provided respectively at least in stop positions of the plurality of stop positions other than the delivery position and the most downstream stop position,
each of the plurality of relay holding units receives and holds the bag from a corresponding transfer holding unit of the plurality of transfer holding units placed in the downstream side arrangement state,
the moving body places the plurality of transfer holding units in the upstream side arrangement state after the bag is released from each of the plurality of transfer holding units placed in the downstream side arrangement state, and
each of the plurality of relay holding units delivers the bag to a corresponding transfer holding unit of the plurality of transfer holding units placed in the upstream side arrangement state.

5. The vacuum package machine as defined in claim 4, wherein:
the second sealing device has a heat plate unit which sandwiches the planned seal portion of the bag, and
the heat plate unit also serves as the relay holding unit provided in the stop position corresponding to the seal position.

6. The vacuum package machine as defined in claim 1, comprises a delivery device which receives the bag which has been subjected to the first sealing process from the packaging device and delivers the bag to the transfer mechanism,
wherein the delivery device includes:
a rotation body which is provided to be rotatable; and
a plurality of delivery holding units which are attached to the rotation body and are each capable of being arranged in a position where the plurality of delivery holding units are able to receive the bag from the packaging device and in a position where the plurality of delivery holding units is able to deliver the bag to the transfer mechanism according to a rotation state of the rotation body.

7. The vacuum package machine as defined in claim 1, wherein,
the packaging device further includes a filling device which puts the content inside the bag while rotationally moving the bag about a filling rotation axis, and
the transfer mechanism transfers the bag from the delivery position to the release position substantially parallel to a straight line connecting the filling rotation axis and the package rotation axis.

8. The vacuum package machine as defined in claim 1, comprising a state determination device which determines, after the second sealing process, a state of an inspection range of the bag that at least partially includes the planned seal portion.

9. The vacuum package machine as defined in claim 8, comprising a sorting device which sorts the bag after being received by the discharge unit according to a determination result of the state of the inspection range.

10. A vacuum package method comprising the steps of:
performing a first sealing process based on an impulse seal method on a bag in a chamber being in a vacuum state while rotationally moving the bag around a package rotation axis, a content being accommodated inside of the bag;
taking the bag having been subjected to the first sealing process out of the chamber and delivering the bag to a transfer mechanism arranged in a delivery position;
conveying the bag from the delivery position to a seal position by the transfer mechanism;
performing a second sealing process based on a heat plate sealing method on a planned seal portion of the bag in the seal position;
performing a cooling process which cools the bag in a cooling position; and
releasing the bag after the cooling process from the transfer mechanism in a release position,
wherein the transfer mechanism linearly transfers the bag in a direction along a surface of the bag from the delivery position to the release position.
